(19) United States
(12) Patent Application Publication
(10) Pub. No.: US 2026/0186511 A1
(43) Pub. Date: Jul. 2, 2026

(54) METHOD AND SYSTEM FOR PERFORMING MULTI-AGENT PATH FINDING FOR A PLURALITY OF MOVING VEHICLES

(71) Applicant: CHINA MOTOR CORPORATION, Taipei (TW)

(72) Inventors: Ju-Ting LAI, Taipei (TW); Yu-Sung CHEN, Taipei (TW)

(73) Assignee: CHINA MOTOR CORPORATION, Taipei (TW)

(21) Appl. No.: 19/004,726

(22) Filed: Dec. 30, 2024

(51) Int. Cl. G05D 1/693; G05D 1/644; G05D 1/646; G05D 105/20; G05D 111/30

(52) U.S. Cl. CPC G05D 1/693; G05D 1/229; G05D 2105/20; G05D 2111/32

(57) ABSTRACT

A system includes a server that stores an environment database therein, and a plurality of moving vehicles. The server calculates, for each of the moving vehicles, using contents of the environment database and a task list, a complete route that includes a plurality of sub-routes, and, when a conflict condition exists between two complete routes, executes a rearrangement procedure to plan a new sub-route for replacing one of the sub-routes to update one of the complete routes. The one of the sub-routes is associated with one of the moving vehicles that is lower in priority order calculated based on priority ranks associated with the task list. In the case that no conflict condition exists, the server transmits the complete routes to the respective moving vehicles, so as to control each of the moving vehicles to move along the respective complete route.

### FIELD

The disclosure relates to a method and a system for path finding, and more particularly to a method and a system for performing multi-agent path finding for a plurality of moving vehicles.

### BACKGROUND

Conventional smart moving vehicles (such as automated guided vehicles, (AGVs)) are configured to move along pre-determined routes, and are currently deployed in applications such as transporting goods.

In the case that a plurality of moving vehicles are to be operated simultaneously, a multi-agent path finding (MAPF) problem needs to be considered. In the field of moving vehicles, the operations of path finding are implemented using existing algorithms such as conflict-based search (CBS), enhanced CBS, etc. Typically, a host computer serving as a central controller implements the path finding for each of the plurality of moving vehicles at a global viewpoint, and also solves potential collisions between paths of different moving vehicles.

It is noted that in order to increase the efficiency of transportation, tasks for the moving vehicles may become complicated, and the path of a specific moving vehicle may include, in addition to a starting point and an end point, one or more stops, a wait period associated with one of the stops, etc. In such cases, the conventional algorithms are typically unable to implement the operations of path finding for multiple moving vehicles.

### SUMMARY

Therefore, an object of the disclosure is to provide a system that is configured to perform multi-agent path finding for a plurality of moving vehicles.

According to one embodiment of the disclosure, the system includes a server and a plurality of moving vehicles. The server includes a data storage unit, a communication unit, and a processing unit connected to the data storage unit and the communication unit.

The data storage unit stores an environment database therein, the environment database including information about a specific geographical area. The processing unit is in communication with a network using the communication unit.

Each of the plurality of moving vehicles includes a movement module, a communication module, and a processing module that is connected to the movement module to control operations of the movement module to move the moving vehicle, and that is connected to the communication module to be in communication with the network.

The processing unit receives a task list via the network, the task list including a plurality of tasks respectively for the plurality of moving vehicles. The task for each of the plurality of moving vehicles including a plurality of route points and a priority rank associated with the task. The plurality of route points including a starting point and at least one stop point. The task for at least one of the plurality of moving vehicles including a plurality of stop points.

The processing unit calculates, for each of the plurality of moving vehicles, using a content of the environment database and a content of the task list, a sub-route for every two successive route points included in the respective task, and obtains, for each of the plurality of moving vehicles, a complete route that starts from the starting point, passes through a middle point of the at least one stop point, and ends at an end point of the at least one stop point, with respect to each of the plurality of moving vehicles.

Each of the sub-routes includes a passing sequence that lists a plurality of locations for the moving vehicle to pass therethrough, and an expected time instance sequence that includes a plurality of time instances respectively associated with the plurality of locations. Each of the plurality of time instances indicates an expected time instance at which the moving vehicle passes through the respective one of the plurality of locations included in the sub-route.

After the complete route for each of the plurality of moving vehicles is obtained, the processing unit performs a conflict check procedure to determine whether a conflict condition between two of the complete routes exists.

In a case where the conflict condition exists, the processing unit extracts the sub-routes, which are relevant to the conflict condition, from the complete routes, and executes a rearrangement procedure to plan a new sub-route for replacing one of the sub-routes, so as to update one of the complete routes, the one of the sub-routes being associated with one of the plurality of moving vehicles that is lower in priority order, the priority order being calculated based on the priority ranks associated with the plurality of tasks.

In a case where no conflict condition exists, the processing unit controls the communication unit to transmit the complete routes to the respective moving vehicles via the network, so as to control each of the plurality of moving vehicles to move along the respective complete route.

Another object of the disclosure is to provide a method that can be implemented using the above-mentioned system.

According to one embodiment of the disclosure, the method includes is implemented using a system that includes a plurality of moving vehicles and a server. The server includes a data storage unit, a communication unit, and a processing unit connected to the data storage unit and the communication unit. The data storage unit stores an environment database therein. The environment database includes information about a specific geographical area. Each of the plurality of moving vehicles including a movement module, a communication module, and a processing module that is connected to the movement module to control operations of the movement module to move the moving vehicle, and that is connected to the communication module to be in communication with a network. the method includes:
receiving, by the processing unit, a task list using the communication unit via the network, the task list including a plurality of tasks respectively for the plurality of moving vehicles, the task for each of the plurality of moving vehicles including a plurality of route points and a priority rank associated with the task, the plurality of route points including a starting point and at least one stop point, the task for at least one of the plurality of moving vehicles including a plurality of stop points;
calculating, by the processing unit, for each of the plurality of moving vehicles, using content of the environment database and a content of the task list, a sub-route for every two successive route points included in the respective task, and obtaining, for each of the plurality of moving vehicles, a complete route that starts from the starting point, passes through a middle point of the at least one stop point, and ends at an end point of the at least one stop point, with respect to each of the plurality of moving vehicles,
each of the sub-routes including a passing sequence that lists a plurality of locations for the moving vehicle to pass therethrough, and an expected time instance sequence that includes a plurality of time instances respectively associated with the plurality of locations, each of the plurality of time instances indicating an expected time instance at which the moving vehicle passes through the respective one of the plurality of locations included in the sub-route; performing, by the processing unit, after the complete route for each of the plurality of moving vehicles is obtained, a conflict check procedure to determine whether a conflict condition between two of the complete routes exists;
in a case where the conflict condition exists, extracting, by the processing unit, the sub-routes, which are relevant to the conflict condition, from the complete routes to execute a rearrangement procedure to plan a new sub-route for replacing one of the sub-routes, so as to update one of the complete routes, the one of the sub-routes being associated with one of the plurality of moving vehicles that is lower in priority order, the priority order being calculated based on the priority ranks associated with the plurality of tasks; and
in a case where no conflict condition exists, controlling, by the processing unit, the communication unit to transmit the complete routes to the respective moving vehicles via the network, so as to control each of the plurality of moving vehicles to move along the respective complete route.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a system for performing multi-agent path finding for a plurality of moving vehicles according to one embodiment of the disclosure.

FIG. 2 is a flow chart illustrating steps of a route planning process of the method for performing multi-agent path finding for a plurality of moving vehicles according to one embodiment of the disclosure.

FIG. 3 illustrates a map of an exemplary geographical area according to one embodiment of the disclosure.

FIG. 4 is a flow chart illustrating a number of sub-steps for calculating a complete route for each of the plurality of moving vehicles according to one embodiment of the disclosure.

FIG. 5 is a flow chart illustrating steps of an exemplary dynamic adjustment process of the method according to one embodiment of the disclosure.

FIG. 6 is a top view of a dynamic window which shows a part of a geographical area near one of the moving vehicles according to one embodiment of the disclosure.

FIG. 7 is a top view of a dynamic window which shows a part of a geographical area near one of the moving vehicles according to one embodiment of the disclosure.

FIG. 8 is a flow chart illustrating steps of an exemplary method for performing multi-agent path finding for a plurality of moving vehicles according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

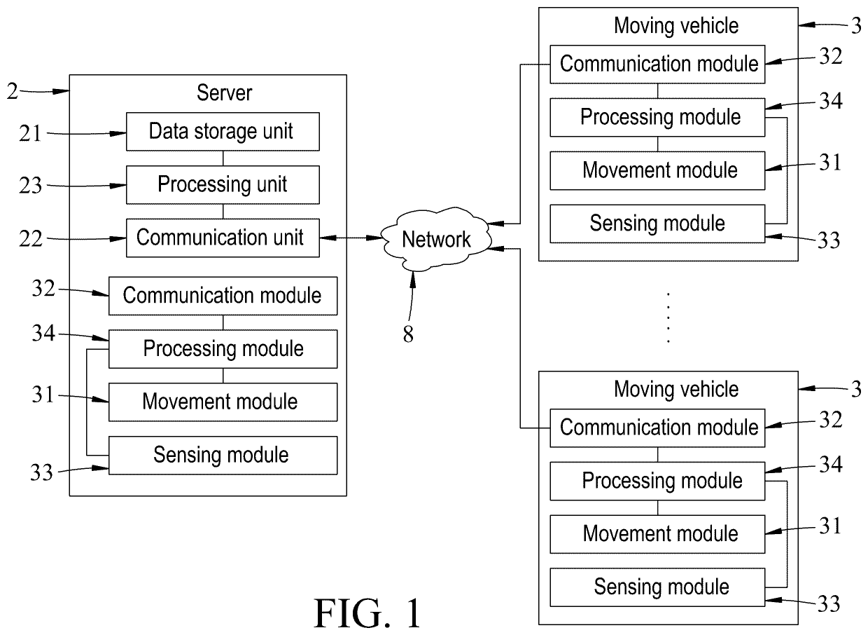

FIG. 1 is a block diagram illustrating components of a system for performing multi-agent path finding (MAPF) for a plurality of moving vehicles according to one embodiment of the disclosure. In the embodiment of FIG. 1, the system includes a server 2 and a plurality of moving vehicles 3.

The server 2 is connected to each of the plurality of moving vehicles 3, and is designated as a host for performing the operations as described below. The server 2 may be embodied using a computer device such as a server device, a personal computer, a laptop, etc., and includes a data storage unit 21, a communication unit 22 and a processing unit 23.

The data storage unit 21 may be embodied using, for example, random access memory (RAM), read only memory (ROM), programmable ROM (PROM), firmware, flash memory, etc. In this embodiment, the data storage unit 21 stores a software application and an environment database therein. The software application may include instructions that, when executed by a processor, cause the processor to implement the operations as described below. The environment database includes information about a specific geographical area, such as a geographical area in which the plurality of moving vehicles 3 are assigned to operate.

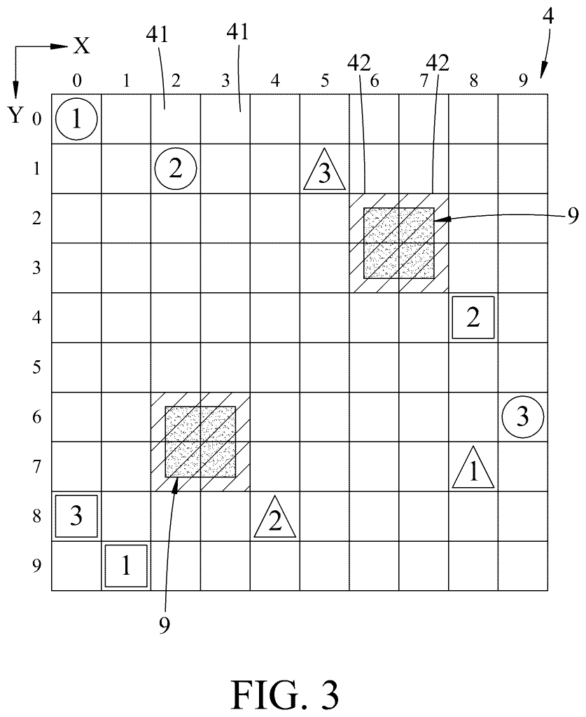

In some embodiments, the environment database may be obtained from a map of the geographical area. FIG. 3 illustrates a map 4 of an exemplary geographical area according to one embodiment of the disclosure. In the example of FIG. 3, the map 4 may be partitioned into a plurality of grid units 41, and may include one or more of obstacles 9.

The communication unit 22 may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. The communication unit 22 enables the server 2 to communicate with each of the plurality of moving vehicles 3 via a network 8 (e.g., the Internet).

The processing unit 23 is connected to the data storage unit 21 and the communication unit 22, and may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. The processing unit 23 is configured to be in communication with the network 8 using the communication unit 22.

In some embodiments, the server 2 may be a computer device disposed on one of the plurality of moving vehicles 3, and may be designated by an operator.

Each of the plurality of moving vehicles 3 may be embodied using a moving robotic device with wheels such as an automated guided vehicle (AVG) or other suitable smart moving vehicles. Each of the plurality of moving vehicles 3 includes a movement module 31, a communication module 32, a sensing module 33, and a processing module 34.

The movement module 31 may be embodied using a motor, a motor driver, and a plurality of wheels. The operations of the movement module 31 may be controlled by the processing module 34 to move the moving vehicle 3. It is noted that using the motor, the motor driver, and the plurality of wheels to move a vehicle is commonly known in the related art, details of which are omitted herein for the sake of brevity.

The communication module 32 may be embodied using components that are similar to the communication unit 22. Each of the plurality of moving vehicles 3 is enabled to communicate with the server 2 via the communication module 32.

The sensing module 33 may be embodied using, for example, a light detection and ranging (LiDAR) component, an odometry, and/or other suitable components for detecting different real time parameters associated with the near environment of the moving vehicle 3. In embodiments, the sensing module 33 further detects a distance and a direction of an obstacle 9 with respect to the moving vehicle 3, and corrects the distance and the direction using the odometry, so as to realize the effect of real time positioning.

It is noted that in the embodiment of FIG. 1, two moving vehicles 3 are present, but in other embodiments, additional moving vehicles 3 may be provided.

In the embodiment of FIG. 1, the processing module 34 may be embodied using an industrial computer (e.g., ARK-2250L manufactured by Advantech®), equipped with a 6th Generation Intel® Core™ U-series Processor that runs on the operating system Ubuntu 18.04, a 4-gigabyte Double Data Rate 3(DDR 3 ) memory module, and six Universal Serial Bus (USB) ports.

In use, the server 2 is configured to receive a task list using the communication unit 22 via the network 8. The task list includes a plurality of tasks for the plurality of moving vehicles 3, respectively. The task for each of the plurality of moving vehicles 3 may include a plurality of route points and a priority rank associated with the task. The route points include a starting point and at least one stop point. In some cases, the tasks for some of the plurality of moving vehicles 3 may include a plurality of stop points. That is to say, some of the plurality of stop points serve as midway stop points.

Generally, the environment database is obtained based on the map of the geographical area, or may be alternatively generated by the server 2 based on the real time parameters associated with the near environment of the plurality of moving vehicles 3. For example, the server 2 may control the plurality of moving vehicles 3 to move around the geographical area, in order to detect map information of the geographical area for constituting the environment database. Specifically, the map information includes locations of walls, obstacles, fences, roads, and additional information for each of the roads such as a shape, a length, a width, a designated moving direction, etc.

In the example of FIG. 3, the map 4 is partitioned by the processing module 34 into the plurality of grid units 41. Each of the plurality of grid units 41 may be defined to have an area that is enough to contain one of the plurality of moving vehicles 3. For example, in this embodiment, each of the plurality of moving vehicles 3 has a length of 120 centimeters and a width of 65 centimeters, and each of the plurality of grid units 41 may be defined as a square with a length of 120 centimeters and a width of 120 centimeters. Then, for each of the plurality of grid units 41, the processing module 34 determines whether more than a predetermined percentage (e.g., 65 percent) of the grid unit 41 is occupied by the obstacles 9. In the case that a specific grid unit 41 has more than the predetermined percentage thereof occupied by the obstacles 9, it may be determined that the specific grid unit 41 cannot be passed, and the processing module 34 may designate the specific grid unit 41 as a blocked unit 42. Then, one of the plurality of grid units 41 is designated as an origin (O) for a two dimensional coordinate system. In the example of FIG. 3, the one of the plurality of grid units 41 on the upper left corner of the map 4 is designated as the origin (O).

In this format, the task for each of the plurality of moving vehicles 3 may be shown on the map 4 graphically. In the example of FIG. 3, the route points for the tasks associated with the three moving vehicles 3 (labeled using the number 1, 2 and 3, respectively) are shown. The route points include a starting point that is represented using a circle, an end point (i.e., one of the stop points) that is represented using a square, and optionally at least one middle point (i.e., a stop point that is between the starting point and the end point) that is represented using a triangle. For one of the moving vehicles 3 that is labeled using the number 1, the starting point, the middle point and the end point thereof may be the grid units 41 represented using the sets of coordinates (0, 0), (8, 7) and (1, 9), respectively.

Using the contents of the environment database and the task list, the processing unit 23 of the server 2 calculates, for each of the moving vehicles 3, a sub-route for every two successive route points included in the respective task, and obtains a complete route that is constituted by the sub-routes and that starts from the starting point, passes through the middle point(s), and ends at the end point.

With respect to each of the moving vehicles 3, each of the sub-routes includes a passing sequence that lists a plurality of grid units 41 for the moving vehicle 3 to pass therethrough, and an expected time instance sequence that includes a plurality of time instances respectively associated with the plurality of grid units 41. Each of the plurality of time instances indicates an expected time instance at which the moving vehicle 3 passes through the respective one of the plurality of grid units 41 included in the sub-route. It is noted that the expected time instance may be calculated using a starting time instance at which the moving vehicle 3 is controlled to start moving alone the associated complete route, the positions of the middle points and the end point, and a pre-determined moving velocity of the moving vehicle 3.

For the one of the moving vehicles 3 that is labeled using the number 1, two different sub-routes may be obtained; one starts from the grid unit 41 represented by (0, 0) to the grid unit 41 represented by (8, 7), and the other starts from the grid unit 41 represented by (8, 7) to the grid unit 41 represented by (1, 9). The complete route is then obtained by combining the two sub-routes. It is noted that the sub-routes are generally calculated to not pass through the blocked units 42.

After the complete route for each of the moving vehicles 3 is obtained, the processing unit 23 of the server 2 performs a conflict check procedure to determine whether a conflict condition exists. Specifically, the conflict condition indicates that two different complete routes have a same grid unit 41 and a same associated expected time instance (meaning that two different moving vehicles 3 may run into each other on the same grid unit 41 at the expected time instance).

In the case that a conflict condition exists, the processing unit 23 extracts the relevant sub-routes from the complete routes, and executes a rearrangement procedure.

In some embodiments, the conflict check procedure includes the processing unit 23 selecting two of the complete routes as a pair of complete routes, comparing the pair of complete routes, and determining whether a conflict condition exists between the pair of complete routes. This step may be then repeated with respect to other pairs of complete routes until all combinations of pairs of complete routes are processed.

In the case that a conflict condition exists, the rearrangement procedure may be implemented by the processing unit 23 with respect to those of the moving vehicles 3 having the complete routes detected with the conflict condition (i.e., the relevant moving vehicles 3), and with respect to priority order that is calculated from the priority ranks associated with the tasks. The relevant moving vehicles 3, and the expected time instance and the grid unit 41 that are associated with the conflict condition may be aggregated as constraint information.

In some embodiments, the priority order may indicate a priority for the relevant moving vehicles 3; for example, the moving vehicle 3 with a higher ranking is sorted on the top of the priority order and the moving vehicle 3 with a lower ranking is sorted on the bottom of the priority order.

In some embodiments, the priority order may be determined based on an order in which the complete routes are calculated. Specifically, the moving vehicle 3 with its complete route calculated earlier may be automatically on the top of the priority order, and the moving vehicle 3 with its complete route calculated later may be automatically on the bottom of the priority order. In the case that a conflict condition exists, the rearrangement procedure may be implemented to adjust the complete route of the moving vehicle 3 on the bottom of the priority order.

In some embodiments, a number of avoid tactics may be implemented in the rearrangement procedure. For example, a pausing time may be added in the complete route of the moving vehicle 3 with a lower ranking prior to the moving vehicle 3 with a lower ranking approaching the grid unit 41 that is associated with the conflict condition, so as to allow the moving vehicle 3 with a higher ranking to move through the grid unit 41 associated with the conflict condition. Alternatively, the velocity of the moving vehicle 3 with a lower ranking may be adjusted such that the moving vehicles 3 pass the grid unit 41 associated with the conflict condition in different time instances. Alternatively, the relevant sub-route of the complete route for the moving vehicle 3 with a lower ranking may be discarded, and a new sub-route that avoids the grid unit 41 associated with the conflict condition may be calculated to replace the old one. That is to say, the relevant sub-route of the moving vehicle 3 that is ranked lower in the priority order is updated with the new sub-route.

In some embodiments, the priority order is calculated based on additional information such as one or more of a remaining power of each of the moving vehicles 3 having the complete routes detected with the conflict condition, a speed limit (upper or lower limits) of each of the moving vehicles 3, a user-input setting, etc., but is not limited to such.

In the example of FIG. 3, the processing unit 23 may determine that the sub-route of the moving vehicle 3 labeled number 1 from the grid unit (0, 0) to the grid unit (8, 7) and the sub-route of the moving vehicle 3 labeled number 2 from the grid unit (2, 1) to the grid unit (4, 8) may cause a conflict condition because the two sub-routes intersect with each other. As such, the processing unit 23 may determine which moving vehicle 3 is ranked lower in the priority order (e.g., the moving vehicle 3 labeled number 2), and proceed to calculate a new sub-route for that moving vehicle 3, and to update the sub-route of the moving vehicle 3 with the new sub-route.

On the other hand, in the case that the processing unit 23 determines no conflict condition exists, the processing unit 23 controls the communication unit 22 to transmit the complete routes to the respective moving vehicles 3 via the network 8, so as to control each of the moving vehicles 3 to move along the respective complete route.

Afterwards, while each of the moving vehicles 3 is moving along the respective complete route, the sensing module 33 is activated to detect the real time parameters associated with the near environment of the moving vehicle 3 and to transmit the real time parameters to the processing module 34. As such, the processing module 34 is configured to implement computation in real time to determine whether the moving vehicle 3 may collide with the obstacles 9. In the case that it is determined that a collision is imminent, the processing module 34 may adjust the relevant sub-route to avoid the collision.

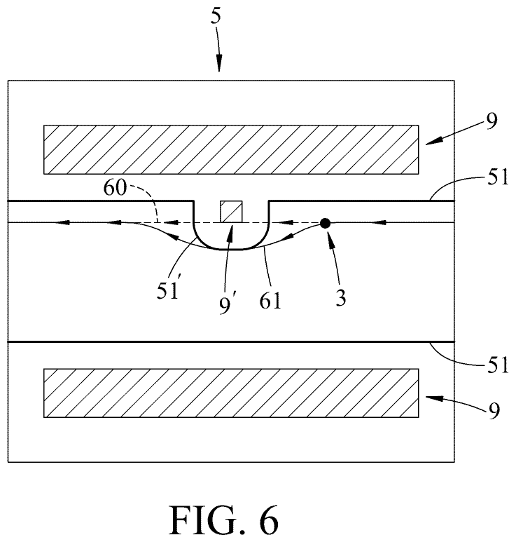

FIG. 6 is a top view of a dynamic window 5 which shows a part of the geographical area near one of the moving vehicles 3 according to one embodiment of the disclosure. In the example of FIG. 6, the processing module 34 is configured to generate the dynamic window 5 based on the environment database and the real time parameters from the sensing module 33. The moving vehicle 3 is configured to move along a sub-route 60. With the obstacles 9 that are obtained in the environment database, the processing module 34 determines a number of buffering margins 51 that expand from each of the obstacles 9 for a predetermined distance (which may be adjusted based on the velocity of the moving vehicle 3), and the moving vehicle 3 is controlled to not cross any one of the buffering margins 51 so as to avoid collisions with the obstacles 9.

In the case that a new obstacle 91 not in the environment database (e.g., a pedestrian) is detected, another buffering margin 51′ is generated. When it is determined that the sub-route 60 crosses the buffering margin 51′, the processing module 34 calculates a new sub-route 61 that moves around the buffering margin 51′, thereby avoiding collisions with the obstacle 91.

In some embodiments, the processing module 34 may be further configured to calculate a straying distance which is the longest distance between the new sub-route 61 and the sub-route 60. When it is determined that the straying distance is larger than a pre-determined threshold, the processing module 34 controls the communication module 32 to transmit the real time parameters to the communication unit 22 via the network 8. In response to receipt of the real time parameters, the processing unit 23 calculates a new complete route for the moving vehicle 3 further based on the real time parameters, implements the conflict check procedure again, and controls the communication unit 22 to transmit the new complete route to the communication module 32 via the network 8 to update the complete route. In some cases, the processing unit 23 may update the environment database using the real time parameters.

In some embodiments, when the processing module 34 is unable to calculate a new sub-route 61 that can avoid a potential collision based on the real time parameters (e.g., a large new obstacle 91 blocks all available paths of the moving vehicle 3), the processing module 34 controls the communication module 32 to transmit the real time parameters to the communication unit 22 via the network 8. In response to receipt of the real time parameters, the processing unit 23 calculates a new complete route for the moving vehicle 3 further based on the real time parameters, implements the conflict check procedure again, and controls the communication unit 22 to transmit the new complete route to the communication module 32 via the network 8 to update the complete route. In some cases, in response to receipt of the real time parameters, the processing unit 23 may update the environment database using the real time parameters.

In some embodiments, while each of the moving vehicles 3 is moving along the respective complete route, the processing module 34 may be activated to continuously determine whether a short cut exists for the moving vehicle 3 based on the real time parameters.

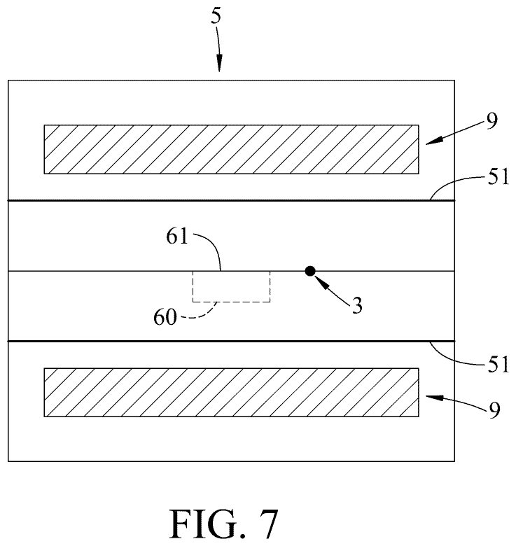

FIG. 7 is a top view of a dynamic window 5 which shows a part of the geographical area near one of the moving vehicles 3 according to one embodiment of the disclosure. In the example of FIG. 7, the sub-route 60 includes a detour that may be deemed to be unnecessary as the moving vehicle 3 is able to move along the straight line without crossing any one of the buffering margins 51. As such, the processing module 34 calculates the new sub-route 61 to update the sub-route 60.

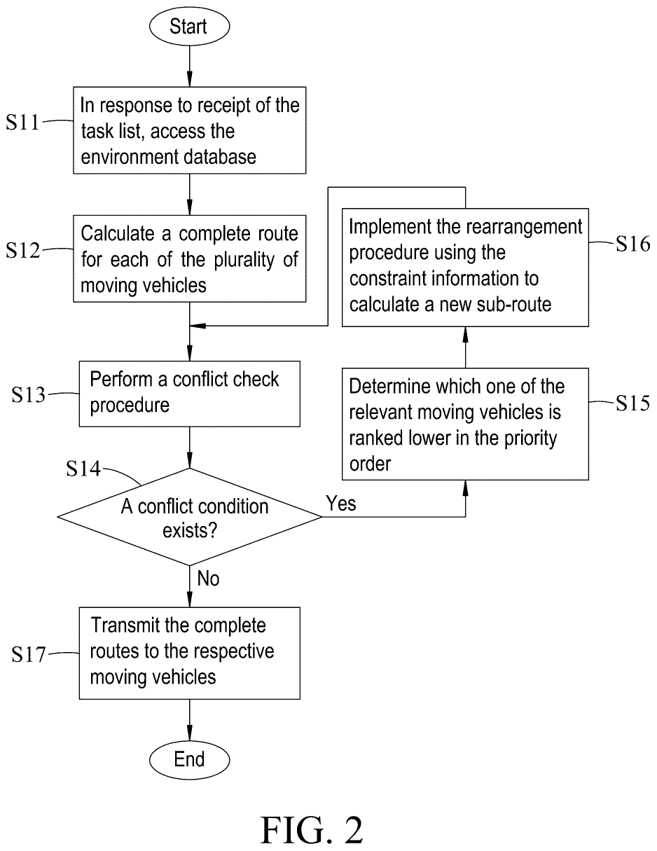

In use, the system is configured to implement a method for performing multi-agent path finding for a plurality of moving vehicles. In some embodiments, the method includes a route planning process in which the server 2 calculates a complete route for each of the plurality of moving vehicles 3, and a dynamic adjustment process, in which each of the plurality of moving vehicles 3 dynamically adjusts the respective complete route based on the real time parameters associated with the near environment. FIG. 2 is a flow chart illustrating steps of the route planning process of the method for performing multi-agent path finding for a plurality of moving vehicles according to one embodiment of the disclosure. In the embodiment of FIG. 2, the route planning process is implemented using the system of FIG. 1.

In step S11, in response to receipt of the task list via the network 8, the processing unit 23 of the server 2 accesses the environment database. Then, in step S12, the processing unit 23 calculates a complete route for each of the plurality of moving vehicles 3. The complete route may include a plurality of sub-routes.

After the complete route for each of the moving vehicles 3 is obtained, in step S13, the processing unit 23 of the server 2 performs a conflict check procedure to determine, in step S14, whether a conflict condition exists.

In the case that a conflict condition exists, the processing unit 23 extracts the relevant sub-routes from the complete routes, and executes a rearrangement procedure.

Specifically, in step S15, the processing unit 23 extracts the relevant sub-routes from the complete routes and, and in step S16, the processing unit 23 implements the rearrangement procedure using the constraint information, in order to calculate a new sub-route for the one of the relevant moving vehicles 3 that is ranked lower in the priority order.

Afterwards, the flow goes back to step S13, and the route planning process continues until it is determined that no conflict condition exists among all the complete routes, and the flow proceeds to step S17, in which the processing unit 23 controls the communication unit 22 to transmit the complete routes to the respective moving vehicles 3 via the network 8, so as to control each of the moving vehicles 3 to move along the respective complete route. As such, the route planning process is completed.

It is noted that the operations of steps S12 to S16 may be seen as a two-layer procedure, with the operations of steps S15 and S16 being associated with planning a new sub-route for a moving vehicle 3 that is ranked lower in the priority order using the constraint information (that is, in a “lower layer”). In embodiments, the planning may be implemented using pathfinding algorithms for a single moving vehicle such as the A* search algorithm, Dijkstra's algorithm, Bellman-Ford algorithm, Floyd-Warshall algorithm, etc. After the new sub-route is planned for the moving vehicle 3 that is ranked lower in the priority order, the flow goes back to steps S13 to S14 to determine, from the perspective of the complete routes (that is, in a “higher layer”), whether a conflict condition exists. The route planning process continues until it is determined that no conflict condition exists among all the complete routes.

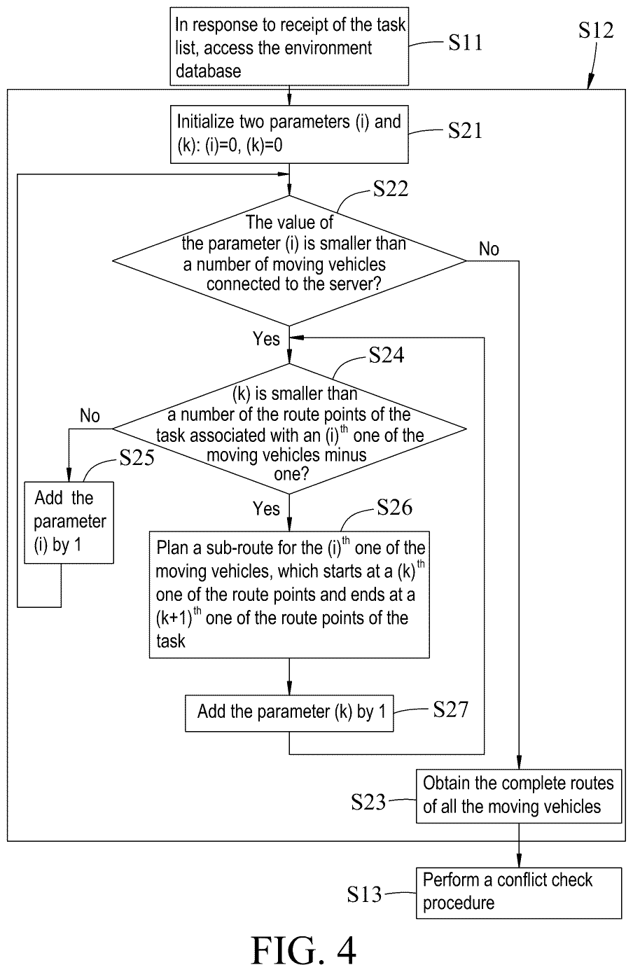

In some embodiments, the operations of step S12 may be implemented by the processing unit 23 executing a program module stored in the data storage unit 21 to perform a series of actions. FIG. 4 is a flow chart illustrating a number of sub-steps of step S12 for calculating a complete route for each of the plurality of moving vehicles 3 according to one embodiment of the disclosure.

It is noted that for the purpose of description, in the example, the number of moving vehicles 3 is set to (m), and may be represented from a 0^{th} one to a (m−1)^{th} one, and for each task, a number of the route points of the task is set to (n), may be represented from a 0^{th} one to a (n−1)^{th} one.

In sub-step S21, the processing unit 23 initializes two parameters (i) and (k); that is, the values of the parameters (i) and (k) are set to zero.

In sub-step S22, the processing unit 23 determines whether the value of the parameter (i) is smaller than a number of the plurality of moving vehicles 3 connected to the server 2. In the case that the determination is affirmative, the flow proceeds to sub-step S24. Otherwise, the flow proceeds to sub-step S23.

In sub-step S24, the processing unit 23 determines whether the value of the parameter (k) is smaller than a number of the route points minus one, which equals (n−1), with respect to the task associated with an (i)^{th} one of the moving vehicles 3. In other words, the determination is whether the value of the parameter (k) is smaller than the number of sub-routes to be included in the complete route. In the case that the determination is affirmative, the flow proceeds to sub-step S26. Otherwise, the flow proceeds to sub-step S25.

In sub-step S26, the processing unit 23 plans a sub-route for the (i)^{th} one of the moving vehicles 3, which starts at a (k)^{th} one of the route points of the task and ends at a (k+1)^{th} one of the route points of the task.

Then, in sub-step S27, the processing unit 23 adds the parameter (k) by 1, and the flow goes back to sub-step S24. That is to say, the processing unit 23 is configured to plan the sub-routes, which connect all of the route points included in the task, for the (i)^{th} one of the moving vehicles 3, resulting in a complete route (i.e., the determination of sub-step S24 becomes negative). Then, the flow proceeds to sub-step S25, in which the processing unit 23 adds the parameter (i) by 1, and the flow goes back to sub-step S22.

As such, the processing unit 23 is configured to plan the sub-routes, which connect all of the route points included in the task, for a next one of the moving vehicles 3, resulting in a complete route. The loop then continues until complete routes for all the moving vehicles 3 connected to the server 2 are planned (i.e., the determination of sub-step S22 becomes negative), and the flow proceeds to sub-step S23, in which the processing unit 23 obtains the complete routes of all the moving vehicles 3 connected to the server 2.

After the complete routes of all the moving vehicles 3 connected to the server 2 are planned and adjusted for avoiding potential collisions, the route planning process is completed, and the moving vehicles 3 may be independently controlled by the respective processing modules 34 to start moving along the complete routes.

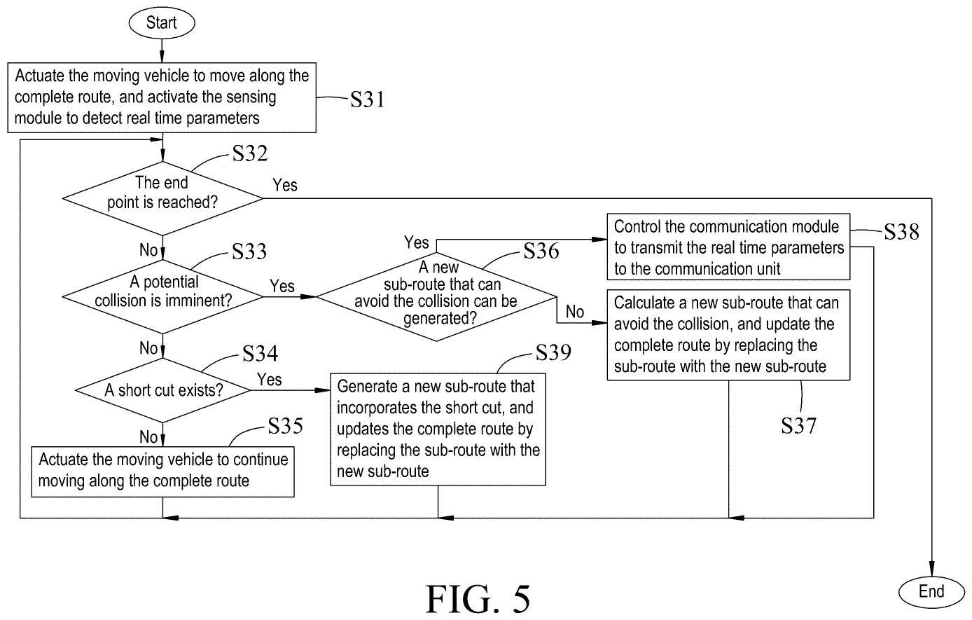

FIG. 5 is a flow chart illustrating steps of an exemplary dynamic adjustment process of the method according to one embodiment of the disclosure. In the embodiment of FIG. 5, the dynamic adjustment process is implemented using the moving vehicles 3 connected to the server 2 of the system of FIG. 1. For the simplicity of description, the operations of the dynamic adjustment process is described with respect to a single moving vehicle 3.

In step S31, in response to receipt of the complete route from the server 2, the processing module 34 controls the movement module 31 to actuate the moving vehicle 3 to move along the complete route, and activates the sensing module 33 to detect different real time parameters associated with the near environment of the moving vehicle 3. In some embodiments, the server 2 may be in communication with the moving vehicles 3 using a data distribution service (DDS), and the server 2 and the moving vehicles 3 may be a multi-vehicle structure with the server 2 acting as a central server of the structure.

As the moving vehicle 3 moves, the processing module 34 continuously receives the real time parameters from the sensing module 33 to determine, in step S32, whether the end point is reached based on the real time parameters and the complete route. In the case that the determination of step S32 is affirmative, the moving vehicle 3 is deemed to have completed the complete route (i.e., the task is completed), and the processing module 34 controls the movement module 31 to stop moving the moving vehicle 3.

Otherwise, when the complete route has not been completed, the flow proceeds to step S33, in which the processing module 34 determines whether a potential collision is imminent. The determination of step S33 may be done by generating a dynamic window 5 in a manner shown in FIGS. 6 and 7 based on the environment database and the real time parameters from the sensing module 33. In the case that it is determined that the moving vehicle 3 moving along one of the sub-routes of the complete route is crossing one of the buffering margins 51, the processing module 34 may determine that a potential collision is imminent, and the flow proceeds to step S36. Otherwise, the flow proceeds to step S34.

In step S36, the processing module 34 determines whether a new sub-route that can avoid the collision can be generated (i.e., whether the collision can be avoided based on the available information). In the case that the determination is affirmative, the flow proceeds to step S37, in which the processing module 34 calculates a new sub-route that can avoid the collision, and updates the complete route by replacing the sub-route with the new sub-route. Then, the flow goes back to step S32.

In the case that the determination of step S36 is negative (i.e., the processing module 34 is unable to calculate a new sub-route that can avoid a potential collision based on the real time parameters), the flow proceeds to step S38, in which the processing module 34 controls the communication module 32 to transmit the real time parameters to the communication unit 22 via the network 8. In response to receipt of the real time parameters, the processing unit 23 calculates a new complete route for the moving vehicle 3 further based on the real time parameters, implements the conflict check procedure again, and controls the communication unit 22 to transmit the new complete route to the communication module 32 via the network 8 to update the complete route by using the new complete route to replace the complete route. Afterwards, the flow goes back to step S32.

In step S34, the processing module 34 determines whether a short cut exists for the moving vehicle 3 based on the real time parameters. In the case that the processing module 34 determines that a short cut exists for the moving vehicle 3, the flow proceeds to step S39, in which the processing module 34 generates a new sub-route that incorporates the short cut, and updates the complete route by replacing the sub-route with the new sub-route. Then, the flow goes back to step S32. Otherwise, the flow proceeds to step S35, in which the processing module 34 controls the movement module 31 to actuate the moving vehicle 3 to continue moving along the complete route, and the flow goes back to step S32.

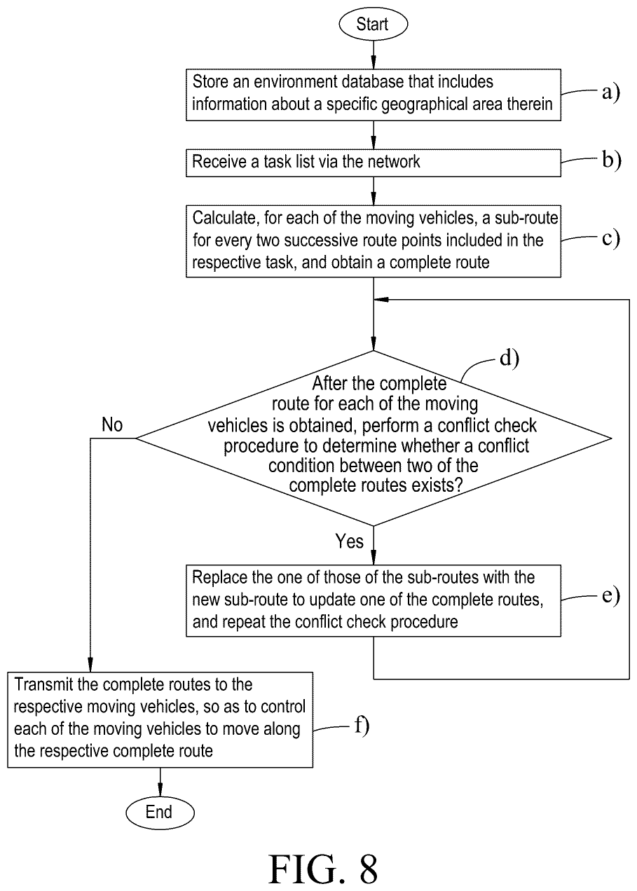

According to one embodiment of the disclosure, a method for performing multi-agent path finding for a plurality of moving vehicles is provided. FIG. 8 is a flow chart illustrating the steps of an exemplary method according to one embodiment of the disclosure. In the embodiment of FIG. 8, the method is implemented using the system of FIG. 1.

In step a), the data storage unit 21 of the server 2 stores an environment database that includes information about a specific geographical area therein.

In step b), the communication unit 22 of the server 2 receives a task list via the network 8. The task list includes a plurality of tasks for the moving vehicles 3, respectively. The task for each of the plurality of moving vehicles 3 includes a plurality of route points and a priority rank associated with the task. The route points include a starting point and at least one stop point. The task for at least one of the plurality of moving vehicles 3 includes a plurality of stop points.

In step c), using the content of the environment database and the content of the task list, the processing unit 23 calculates, for each of the moving vehicles 3, a sub-route for every two successive route points included in the respective task, and obtains a complete route that starts from the starting point, passes through a middle point of the at least one stop point, and ends at an end point of the at least one stop point. With respect to each of the moving vehicles 3, each of the sub-routes includes a passing sequence that list a plurality of locations for the moving vehicle 3 to pass therethrough, and an expected time instance sequence that includes a plurality of time instances respectively associated with the plurality of locations. Each of the plurality of time instances indicates an expected time instance at which the moving vehicle 3 passes through the respective one of the plurality of locations included in the sub-route.

In step d), after the complete route for each of the moving vehicles 3 is obtained, the processing unit 23 performs a conflict check procedure to determine whether a conflict condition between two of the complete routes exists. In the case that a conflict condition exists, the processing unit 23 extracts those of the sub-routes relevant to the conflict condition from the complete routes, and executes a rearrangement procedure to plan a new sub-route for replacing one of those of the sub-routes. In embodiments, the one of those of the sub-routes is associated with one of the moving vehicles 3 that is ranked lower in priority order.

In some embodiments, the processing unit 23 implements the conflict check procedure by comparing two different complete routes associated with two different moving vehicles 3, and the conflict condition indicates that the two different complete routes have a same location and a same associated expected time instance.

In the case that a conflict condition exists, the processing unit 23 implements the rearrangement procedure by aggregating those of the moving vehicles 3 having the complete routes detected with the conflict condition, and the expected time instance and the location that are associated with the conflict condition as constraint information, and planning a new sub-route using the constraint information and the content of the task list.

In step e), the processing unit 23 replaces the one of those of the sub-routes with the new sub-route to update one of the complete routes, and repeats the conflict check procedure.

In step f), in the case that no conflict condition exists, the processing unit 23 controls the communication unit 22 to transmit the complete routes to the respective moving vehicles 3 via the network 8, so as to control each of the moving vehicles 3 to move along the respective complete route.

To sum up, embodiments of the disclosure provide a system and a method for performing multi-agent path finding for a plurality of moving vehicles. The system and method of the disclosure provide at least the following effects.

The system and the method of the disclosure are configured to calculate the complete route for each of the moving vehicles by dividing the complete route into multiple sub-routes, and obtains the passing sequence and the expected time instance sequence for each of the sub-routes. As such, the potential conflict between the moving vehicles may be easily detected and avoided, making the system and the method particularly useful in performing multi-agent path finding for a large number of moving vehicles.

Moreover, each of the plurality of moving vehicles is configured to individually detect real time parameters associated with the near environment of the moving vehicle, and determine whether the originally received complete route needs to be adjusted based on the real time parameters. That is to say, the system first implements centralized planning for distributed plans to calculate the complete route for each of the moving vehicles, and afterwards, each of the plurality of moving vehicles implements decentralized planning for distributed plans to dynamically adjust its complete route to avoid a potential collision caused by any real time conditions.

Additionally, each of the plurality of moving vehicles is configured to determine whether a short cut, compared to the originally received complete route, exists. In the case that a short cut exists, the moving vehicle may adjust a sub-route of the complete route so as to optimize the complete route.

In embodiments, the real time parameters detected by each of the plurality of moving vehicles may be transmitted back to the server, so that the environment database may be updated for subsequent use.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A system for performing multi-agent path finding for a plurality of moving vehicles, comprising:
a server that includes
a data storage unit storing an environment database therein, the environment database including information about a specific geographical area,
a communication unit, and
a processing unit connected to the data storage unit and the communication unit, and being in communication with a network using the communication unit; and
a plurality of moving vehicles, each of the plurality of moving vehicles including a movement module, a communication module, and a processing module that is connected to the movement module to control operations of the movement module to move the moving vehicle, and that is connected to the communication module to be in communication with the network,
wherein:
the processing unit receives a task list via the network, the task list including a plurality of tasks respectively for the plurality of moving vehicles, the task for each of the plurality of moving vehicles including a plurality of route points and a priority rank associated with the task, the plurality of route points including a starting point and at least one stop point, the task for at least one of the plurality of moving vehicles including a plurality of stop points;
the processing unit calculates, for each of the plurality of moving vehicles, using content of the environment database and a content of the task list, a sub-route for every two successive route points included in the respective task, and obtains, for each of the plurality of moving vehicles, a complete route that starts from the starting point, passes through a middle point of the at least one stop point, and ends at an end point of the at least one stop point, with respect to each of the plurality of moving vehicles,
each of the sub-routes includes a passing sequence that lists a plurality of locations for the moving vehicle to pass therethrough, and an expected time instance sequence that includes a plurality of time instances respectively associated with the plurality of locations, each of the plurality of time instances indicating an expected time instance at which the moving vehicle passes through the respective one of the plurality of locations included in the sub-route;
after the complete route for each of the plurality of moving vehicles is obtained, the processing unit performs a conflict check procedure to determine whether a conflict condition between two of the complete routes exists;
in a case where the conflict condition exists, the processing unit extracts the sub-routes, which are relevant to the conflict condition, from the complete routes, and executes a rearrangement procedure to plan a new sub-route for replacing one of the sub-routes, so as to update one of the complete routes, the one of the sub-routes being associated with one of the plurality of moving vehicles that is lower in priority order, the priority order being calculated based on the priority ranks associated with the plurality of tasks; and
in a case where no conflict condition exists, the processing unit controls the communication unit to transmit the complete routes to the respective moving vehicles via the network, so as to control each of the plurality of moving vehicles to move along the respective complete route.

2. The system as claimed in claim 1, wherein the processing unit implements the conflict check procedure by comparing two different complete routes associated with two different moving vehicles, and the conflict condition indicates that the two different complete routes have a same location and a same associated expected time instance.

3. The system as claimed in claim 1, wherein the processing unit implements the rearrangement procedure by aggregating those of the plurality of moving vehicles having the complete routes detected with the conflict condition, and the expected time instance and the location associated with the conflict condition as constraint information, and planning a new sub-route using the constraint information and the content of the task list.

4. The system as claimed in claim 1, wherein the priority order is further calculated based on one or more of a remaining power of each of the plurality of moving vehicles, a speed limit of each of the plurality of moving vehicles, and a user-input setting.

5. The system as claimed in claim 1, wherein:
each of the plurality of moving vehicles further includes a sensor module that is connected to the processing module and that detects a plurality of real time parameters associated with a near environment of the moving vehicle as the moving vehicle moves along the respective complete route, and the sensor module transmits the plurality of real time parameters to the processing module;
the processing module determines whether a collision is imminent based on the plurality of real time parameters, and in a case where it is determined that the collision is imminent, the processing module calculates a new sub-route that avoids the collision and updates the complete route by using the new sub-route to replace the sub-route, which is relevant to the collision.

6. The system as claimed in claim 5, wherein the processing module further determines whether a short cut exists based on the real time parameters, and in a case where it is determined that the short cut exists, the processing module calculates a new sub-route that incorporates the short cut and updates the complete route by using the new sub-route to replace the sub-route, which is relevant to the short cut.

7. The system as claimed in claim 5, wherein, in a case where the processing module is unable to calculate a new sub-route to avoid a potential collision:
the processing module controls the communication module to transmit the real time parameters to the communication unit via the network; and
in response to receipt of the real time parameters, the processing unit calculates a new complete route for the moving vehicle further based on the real time parameters, and controls the communication unit to transmit the new complete route to the communication module via the network to update the complete route by using the new complete route to replace the complete route.

8. The system as claimed in claim 7, wherein, in response to receipt of the real time parameters, the processing unit updates the environment database using the real time parameters.

9. A method for performing multi-agent path finding for a plurality of moving vehicles, the method being implemented using a system that includes a plurality of moving vehicles and a server, the server including a data storage unit, a communication unit, and a processing unit connected to the data storage unit and the communication unit, the data storage unit storing an environment database therein, the environment database including information about a specific geographical area, each of the plurality of moving vehicles including a movement module, a communication module, and a processing module that is connected to the movement module to control operations of the movement module to move the moving vehicle, and that is connected to the communication module to be in communication with a network, the method comprising;
receiving, by the processing unit, a task list using the communication unit via the network, the task list including a plurality of tasks respectively for the plurality of moving vehicles, the task for each of the plurality of moving vehicles including a plurality of route points and a priority rank associated with the task, the plurality of route points including a starting point and at least one stop point, the task for at least one of the plurality of moving vehicles including a plurality of stop points;
calculating, by the processing unit, for each of the plurality of moving vehicles, using a content of the environment database and a content of the task list, a sub-route for every two successive route points included in the respective task, and obtaining, for each of the plurality of moving vehicles, a complete route that starts from the starting point, passes through a middle point of the at least one stop point, and ends at an end point of the at least one stop point, with respect to each of the plurality of moving vehicles,
each of the sub-routes including a passing sequence that lists a plurality of locations for the moving vehicle to pass therethrough, and an expected time instance sequence that includes a plurality of time instances respectively associated with the plurality of locations, each of the plurality of time instances indicating an expected time instance at which the moving vehicle passes through the respective one of the plurality of locations included in the sub-route;
performing, by the processing unit, after the complete route for each of the plurality of moving vehicles is obtained, a conflict check procedure to determine whether a conflict condition between two of the complete routes exists;
in a case where the conflict condition exists, extracting, by the processing unit, the sub-routes, which are relevant to the conflict condition, from the complete routes to execute a rearrangement procedure to plan a new sub-route for replacing one of the sub-routes, so as to update one of the complete routes, the one of the sub-routes being associated with one of the plurality of moving vehicles that is lower in priority order, the priority order being calculated based on the priority ranks associated with the plurality of tasks; and
in a case where no conflict condition exists, controlling, by the processing unit, the communication unit to transmit the complete routes to the respective moving vehicles via the network, so as to control each of the plurality of moving vehicles to move along the respective complete route.
